(19) United States
(12) Patent Application Publication
(10) Pub. No.: US 2015/0077386 A1
(43) Pub. Date: Mar. 19, 2015

(54) SCANNING METHOD WITH ADJUSTABLE SAMPLING FREQUENCY AND TOUCH DEVICE USING THE SAME

(71) Applicant: ELAN MICROELECTRONICS CORPORATION, Hsin Chu (TW)

(72) Inventors: Jung-Shou HUANG, Zhubei City (TW); Chia-Mu WU, Taipei City (TW)

(73) Assignee: ELAN MICROELECTRONICS CORPORATION

(21) Appl. No.: 14/304,636

(22) Filed: Jun. 13, 2014

(30) Foreign Application Priority Data
Sep. 18, 2013 (TW) 102133790

(51) Int. Cl. G06F 3/044

(52) U.S. Cl. CPC G06F 3/044
USPC 345/174

(57) ABSTRACT

A scanning method with adjustable sampling frequency includes steps of pre-scanning a sensing unit of a touch device to acquire capacitance offsets of sensor traces of the sensor unit aligned in at least one of a first-axis direction and a second-axis direction, determining sampling frequencies according to the capacitance offsets of the respective driven sensor traces, and sampling the sensing unit with the determined sampling frequencies. As the capacitance offsets reflect RC load values corresponding to the sensor traces in the first-axis direction, the sampling frequencies can be adjusted according to the actual RC load values when the sensing unit is scanned to receive sensed signals, thereby effectively raising a report rate of touch events.

### BACKGROUND OF THE INVENTION

1. Field of the Invention

The present invention relates to a scanning method of a capacitive touch device, and more particularly to a scanning method with adjustable sampling frequency and a touch device using the scanning method.

2. Description of the Related Art

Capacitive touch device detects a location of an object, such as a finger or a stylus, touching on the touch device by a capacitive variation of corresponding sensor traces. To ensure a correct sensing of capacitive variation caused by the object touching the sensor traces, capacitive touch device usually acquires a reference value through an analog-to-digital conversion (ADC) calibration procedure when being turned on or awakened from a hibernation state. The reference value is taken to determine where the object is actually on the capacitive touch device upon subsequent scanning.

With reference to FIG. 10, a conventional mutual capacitance touch device has a sensing unit 50 and a scanning circuit 60. The sensing unit 50 has multiple first traces and second traces respectively aligned in a first-axis direction and a second-axis direction. The first traces are connected to a driving unit 61 of the scanning circuit 60 and the second traces are connected to a sensing unit 62 of the scanning circuit 60. When performing the ADC calibration procedure upon a mutual-capacitance scan mode, the sensing unit 50 sequentially sends a driving signal to each first trace and receives a sensing value of each second trace with an identical sampling frequency. Suppose that the receiving unit 62 is adjacent to a top one of the first traces Y1 and a top end of each second trace X1˜Xm. With reference to FIGS. 11A and 11B, after the driving signal is outputted to the top first trace Y1, capacitors intersected by the top first trace Y1 and the second traces X1˜Xm are charged by the driving signal to a saturation state or discharged down to zero voltage in a period of time t1 as indicated by two curves L1 and L2. However, after the same driving signal is outputted to a last one of the first traces Yn, capacitors intersected by each second trace X1˜Xm and the last first trace Yn is charged to the saturation state or discharged to the zero voltage in a period of time t2, which is longer than t1. As the receiving unit 62 reads sensed capacitance values of the second traces with a fixed sampling frequency, the fixed sampling frequency should correspond to t2 instead of t1 for receiving correct sensed capacitance.

Different charging and discharging times reside in that a resistor-capacitor (RC) load arising from the driving signal outputted to the last first trace is greater than the RC load arising from the driving signal outputted to each of the rest of the first traces. Hence, the times for charging all intersections on the last first trace to the saturation state or discharging all intersections on the last first trace to the zero voltage are relatively longer. To ensure to receive the correct sensed capacitance values of the second traces each time after the driving signal is outputted, the sampling frequency must be lowered. For example, in the case of a double-layered capacitive touch panel with a total resistance under 20K, the sampling frequency is usually configured from 800K to 500K, and in the case of a single-layered capacitive touch panel with a total resistance from 60K to 80K, the sampling frequency is configured from 300K to 150K. The lowered sampling frequency leads to a lower report rate, which causes unsmooth operation. However, if the sampling frequency is not lowered, there is a likelihood that incorrect capacitance values are received when the capacitors intersected by the first traces and the second traces are not yet fully charged to the saturation state or discharged to zero voltage.

As far as the conventional mutual capacitance touch device is concerned, to tackle the foregoing problems, one solution is proposed to manually measure the RC loads of all the first traces prior to shipment of the conventional mutual capacitance touch device. The conventional mutual capacitance touch device is then scanned with different sampling frequencies and a preferred sampling frequency for scanning the second traces is determined in the end. However, the solution has the shortcoming of being time-consuming in operation.

### SUMMARY OF THE INVENTION

An objective of the present invention is to provide a scanning method with adjustable frequency and a touch device using the scanning method tackling the issues of spending lots of time and cost in manually measuring and testing for the determination of sampling frequency.

To achieve the foregoing object, the scanning method with adjustable sampling frequency for a sensing unit having multiple sensor traces aligned in a first-axis direction and in a second-axis direction, the scanning method comprising steps of:

pre-scanning the sensing unit to acquire a capacitance offset corresponding to each sensor trace in at least one of the first-axis direction and the second-axis direction;

determining a sampling frequency according to the capacitance offset of the sensor trace; and

sampling the sensor unit with the determined sampling frequencies.

To achieve the foregoing objective, alternatively, the scanning method with adjustable sampling frequency for a sensing unit having multiple sensor traces aligned in a first-axis direction and in a second-axis direction, has steps of:

scanning the sensing unit to acquire capacitance offsets of the sensor traces in at least one of the first-axis direction and the second-axis direction;

driving each sensor trace in the first-axis direction;

determining sampling frequencies according to the capacitance offsets of the respective driven sensor traces in the first-axis direction; and

reading sensed capacitance values at locations intersected by the sensor traces in the second-axis direction and the driven sensor traces in the first-axis direction with the corresponding sampling frequencies.

To achieve the foregoing objective, alternatively, the scanning method with adjustable sampling frequency of a sensing unit having multiple sensor traces aligned in a first-axis direction and in a second-axis direction, has steps of:

a pre-scanning procedure having a step of acquiring capacitance offsets corresponding to at least the sensor traces in the first direction; and

a subsequent scanning procedure having steps of:

determining a driving and sampling frequency of each sensor trace in the first-axis direction according to the capacitance offset of the sensor trace in the first-axis direction; and

driving the sensor trace in the first-axis direction and reading sensed capacitance value of the sensor trace in the first-axis direction with the driving and sampling frequency.

To achieve the foregoing objective, the touch device with adjustable sampling frequency has a sensing unit, a driving unit, a receiving unit, and a control unit.

The sensing unit has multiple sensor traces aligned in a first-axis direction and in a second-axis direction.

The driving unit is connected to the sensor traces in the first-axis direction of the sensing unit.

The receiving unit is connected to the sensor traces in the second-axis direction of the sensing unit.

The control unit is connected to the driving unit and the receiving unit, controls the driving unit and the receiving unit to scan the sensing unit so as to acquire capacitance offsets of the sensor traces in at least the first-axis direction, and determines sampling frequencies according to the capacitance offsets of the respective driven sensor traces in the first-axis direction. The receiving unit reads sensed capacitance values at locations intersected by sensor traces in the second-axis direction and the driven sensor traces in the first-axis direction with the corresponding sampling frequencies.

To achieve the foregoing objective, the touch device with adjustable sampling frequency has a sensing unit, a first driving and receiving unit, a second driving and receiving unit, and a control unit.

The sensing unit has multiple sensor traces in the first-axis direction aligned in a first-axis direction and a second-axis direction.

The first driving and receiving unit is connected to the sensor traces in the first-axis direction

The second driving and receiving unit is connected to the sensor traces in the second-axis direction.

The control unit is connected to the first driving and receiving unit and the second driving and receiving unit, controls the first driving and receiving unit and the second driving and receiving unit to pre-scan the sensing unit and at least acquire a capacitance offset of each sensor trace in the first-axis direction, determines a first driving and sampling frequency of each sensor trace in the first-axis direction according to the capacitance offset of the sensor trace in the first-axis direction when subsequently scanning the sensor traces in the first-axis direction, and drives the sensor trace in the first-axis direction and reading sensed capacitance value of the sensor trace in the first-axis direction with the first driving and sampling frequency.

After the touch device performs an analog-to-digital conversion (ADC) calibration procedure, the receiving unit automatically generates a capacitance offset corresponding to each sensor trace connected thereto. Such capacitance offset varies with the RC load value of the sensor traces. Hence, prior to formal scanning, the present invention pre-scans the touch device once first to acquire capacitance offsets corresponding to sensors traces in the first-axis direction or the second-axis direction. Upon formal scanning, the receiving unit configures a sampling frequency of a corresponding driven sensor trace according to the capacitance offset of the driven sensor trace. As to the sensor traces with lower RC load values, higher sampling frequencies are used to receive the sensed capacitance values of the sensor traces. As to the sensor traces with higher RC load values, lower sampling frequencies are used to receive the sensed capacitance values of the sensor traces, thereby fulfilling the goal of automatically adjusting sampling frequency and increasing a report rate of the sensing unit.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a touch device in accordance with the present invention;

FIG. 2A is an electrical functional block of an embodiment of a receiving unit of a scanning circuit in FIG. 1;

FIG. 2B is an electrical functional block of another embodiment of a receiving unit of a scanning circuit in FIG. 1;

FIG. 3A is a circuit diagram of a receiver of the receiving unit in FIG. 2A;

FIG. 3B is a circuit diagram of a receiver of the receiving unit in FIG. 2B;

FIG. 4 is a curve diagram showing a relationship between capacitance offset and sensed capacitance values of three traces driven by the capacitance offset;

FIG. 5 is a flow diagram of a scanning method in accordance with the present invention;

FIG. 6 is a flow diagram of a first embodiment of the scanning method in FIG. 5;

FIG. 7 is a flow diagram of a second embodiment of the scanning method in FIG. 5;

FIG. 8 is an electrical block diagram of a self-capacitance scanning circuit in accordance with the present invention;

FIG. 9 is a flow diagram of a third embodiment of the scanning method in FIG. 5;

FIG. 10 is a schematic view of a conventional touch device; and

FIGS. 11 A and 11B are waveform diagrams showing when the touch device in FIG. 10 drives the first traces Y₁ and Yₙ during a charging process and a discharging process.

### DETAILED DESCRIPTION OF THE INVENTION

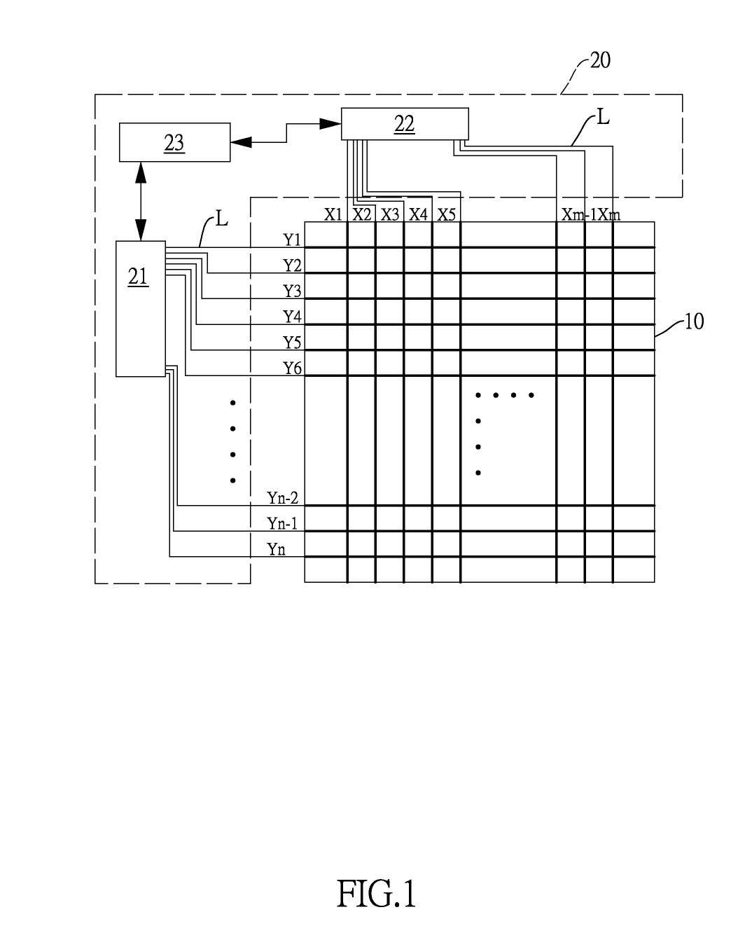

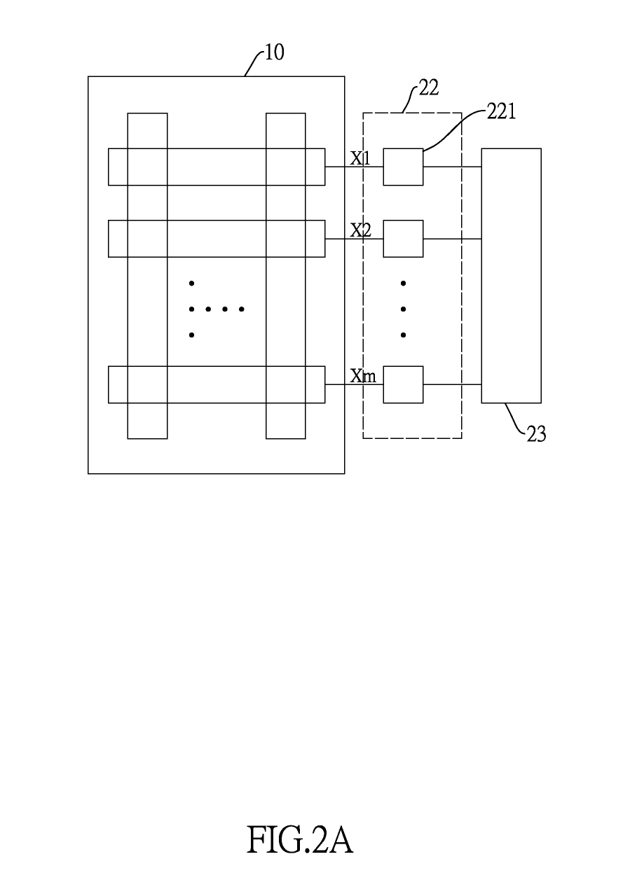

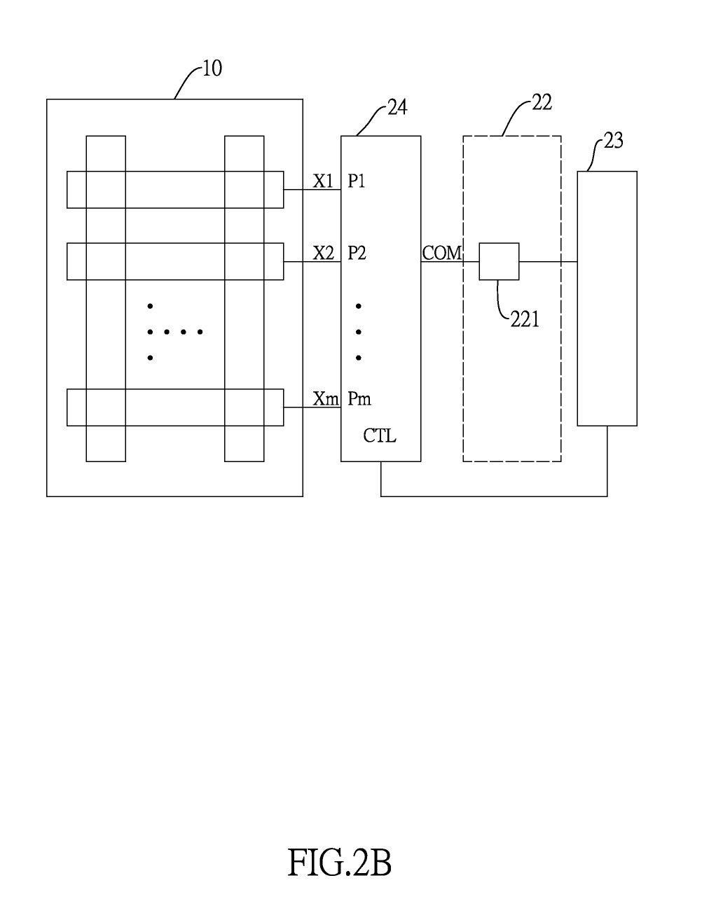

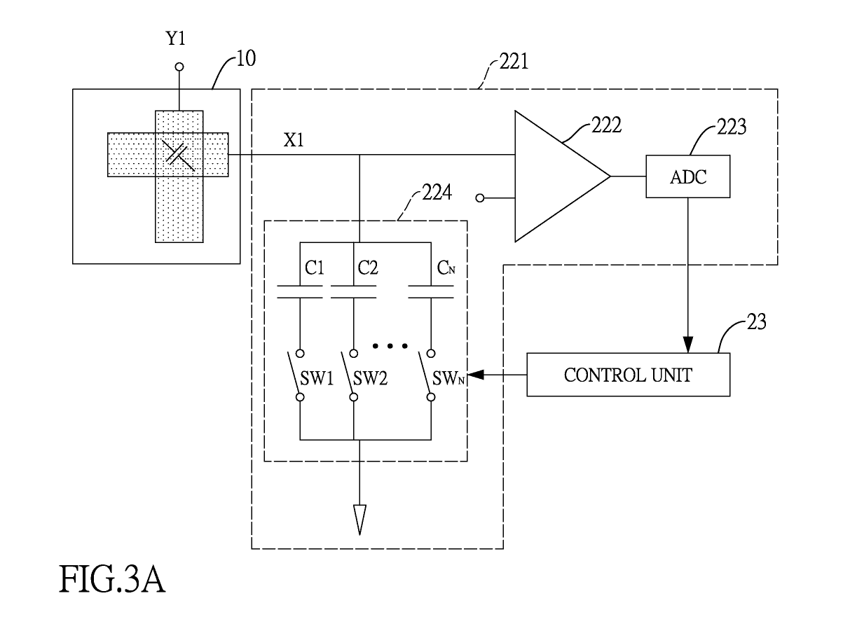

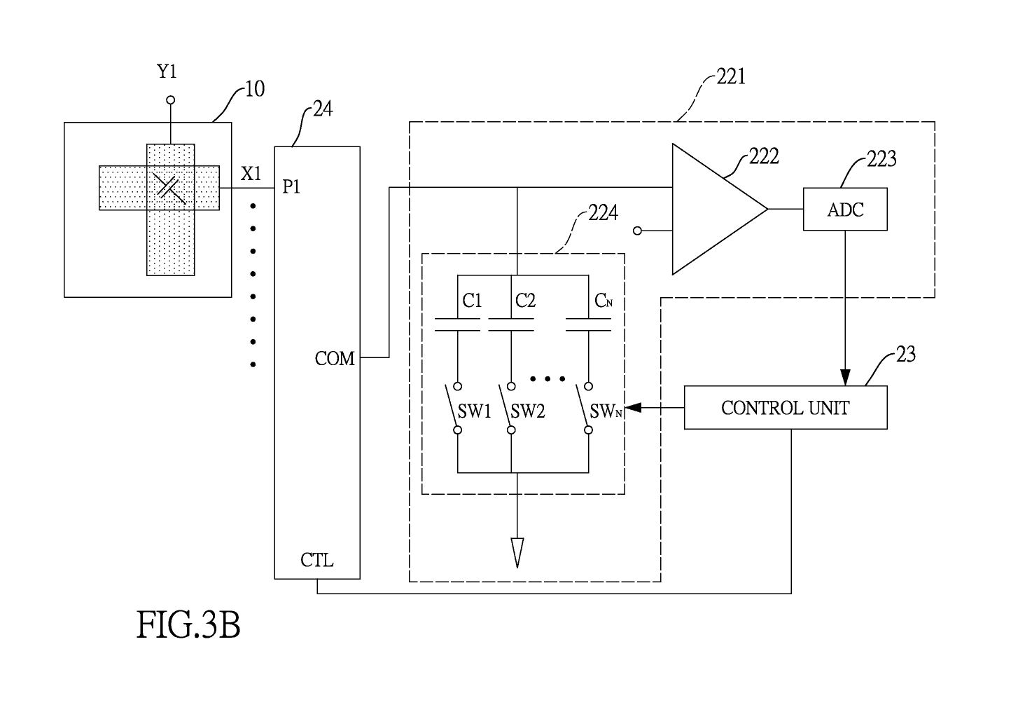

With reference to FIG. 1, a touch device in accordance with the present invention has a sensing unit 10 and a scanning circuit 20. The scanning circuit 20 has a driving unit 21, a receiving unit 22 and a control unit 23 electrically connected to the driving unit 21 and the receiving unit 22. With reference to FIGS. 2A and 3A, an embodiment of the receiving unit 22 has multiple receivers 221 respectively connected to multiple second traces X₁˜Xₘ of the sensing unit 10 aligned in a second-axis direction. Each receiver 221 has a comparator 222, an analog-to-digital converter (ADC) 223, and a variable capacitance compensation circuit 224. One input terminal of the comparator 222 is connected to one end of one of the second traces X₁˜Xₘ and the variable capacitance compensation circuit 224. An output terminal of the comparator 222 is connected to the control unit 23 through the ADC 223 to convert a sensed capacitive signal of the second trace X₁˜Xₘ into a digital capacitance value and then to output the digital capacitance value to the control unit 23. With reference to FIG. 3B, another embodiment of the receiving unit 22 has a multiplexer 24 and a receiver 221. The multiplexer 24 has multiple select terminals, a control terminal and a common terminal. The select terminals are respectively connected to the second traces X₁˜Xₘ. With reference to FIG. 3B, the receiver 221 has a comparison circuit 222, an ADC 223, and a variable capacitance compensation circuit 224. One input terminal of the comparator 222 is connected to the common terminal COM of the multiplexer 24. The control terminal CTL of the multiplexer 24 is connected to the control unit 23. The control unit 23 controls a control terminal CTL of the multiplexer 24 for the multiplexer 24 to select one of the second traces X₁˜Xₘ and receive a sensed capacitance value of the second trace X₁˜Xₘ. The variable capacitance compensation circuit 224 has multiple capacitors C₁˜C_{N} and multiple electronic switches SW₁˜SW_{N}. One end of each capacitor C₁˜C_{N} is connected to the input terminal of the comparator 222. Each electronic switch SW₁˜SW_{N} is connected in series between the other end of a corresponding capacitor C₁˜C_{N} and a ground terminal. The control terminal of each electronic switch SW₁˜SW_{N} is connected to the control unit 23.

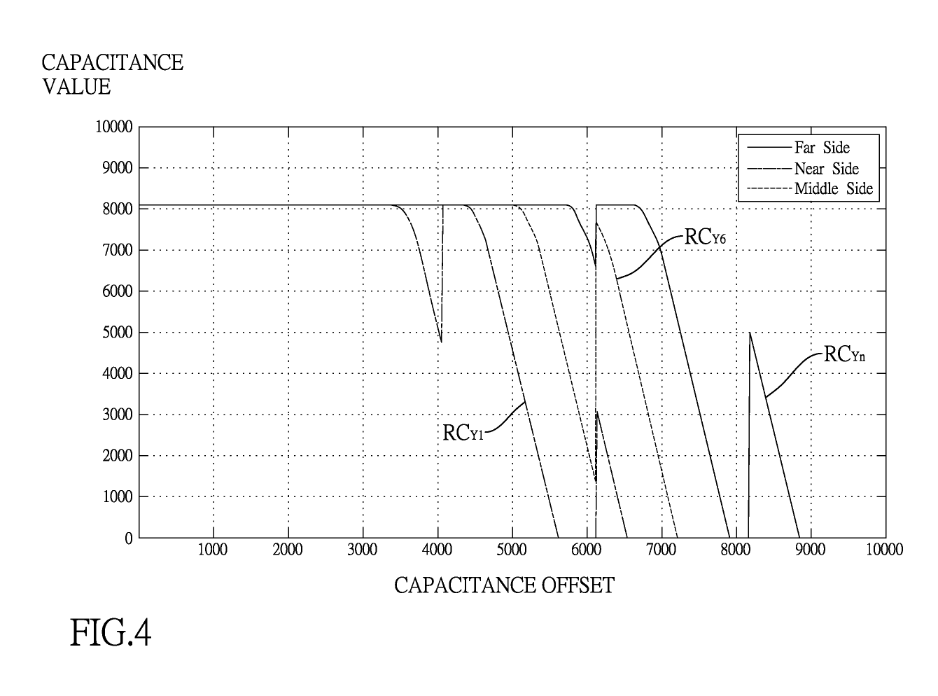

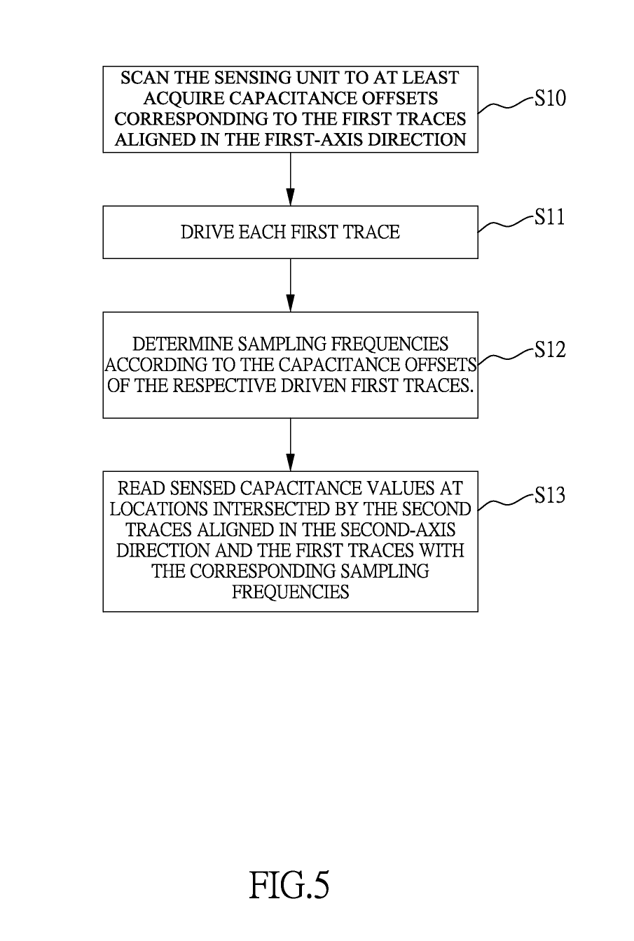

With further reference to FIGS. 3A and 3B, the control unit 23 adjusts a capacitance offset of the variable capacitance compensation circuit 24 according to the digital capacitance value transmitted from the ADC 223. A proper capacitance offset can be determined by turning on or turning off a part of or all the electronic switches SW₁˜SW_{N}. As the capacitance offset varies with the RC loads of sensor traces, the capacitance offset can be estimated by directly sensing the RC load of each sensor trace. With reference to FIG. 4, three curves respectively correspond to three different capacitance offsets estimated by sensing the capacitance values of a top second trace X₁ after the driving signal is outputted to a top first trace Y₁, a middle first trace Y₆ and a bottom first trace Yₙ aligned in a first-axis direction in FIG. 1. The bottom trace Yₙ is farther from the receiving unit 22 than the top first trace Y₁ and the middle first trace Y₆. The RC load for the driving signal to reach the top second trace X₁ through the bottom first trace Yₙ ranks the highest among all the RC loads for the driving signal to reach the top second trace X₁ through all the first traces and the capacitance offset corresponding to the highest RC load is therefore the highest among all the capacitance offsets.

After the touch device performs the ADC calibration procedure, the receiving unit 22 automatically generates a capacitance offset on each second trace X₁˜Xₘ connected to the receiving unit 22. With reference to FIG. 5, a scanning method with adjustable sampling frequency in accordance with the present invention has the following steps.

Step S10: Scan the sensing unit 10 to at least acquire capacitance offsets corresponding to the first traces Y₁˜Yₙ aligned in the first-axis direction. A fixed sampling frequency or different sampling frequencies can be used to scan the sensing unit 10. If better frame rate is taken into account, a fixed higher sampling frequency is desired.

Step S11: Drive each first trace Y₁˜Yₙ.

Step S12: Determine sampling frequencies according to the capacitance offsets of the respective driven first traces Y₁˜Yₙ.

Step S13: Read sensed capacitance values at locations intersected by the second traces X₁˜Xₘ aligned in the second-axis direction and the first traces Y₁˜Yₙ with the corresponding sampling frequencies.

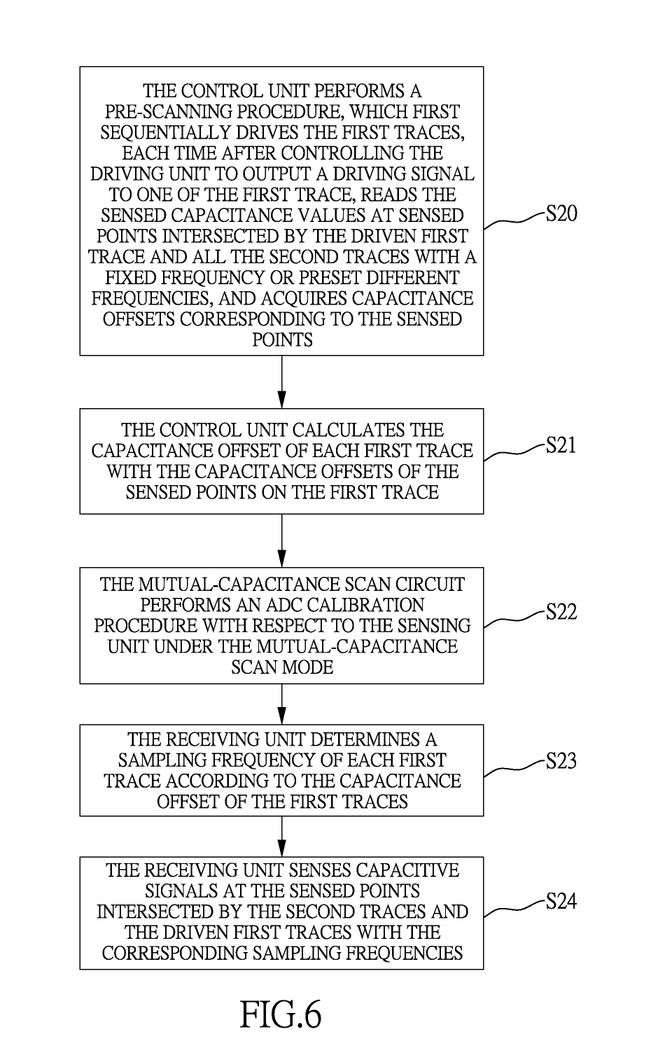

With reference to FIG. 6, a first embodiment of the scanning method in accordance with the present invention is applied to a mutual-capacitance scan circuit, is performed by the touch device under a mutual-capacitance scan mode and has the following steps.

Step S20: The control unit 23 performs a pre-scanning procedure, which first sequentially drives the first traces Y₁˜Yₙ, each time after controlling the driving unit 21 to output a driving signal to one of the first traces Y₁˜Yₙ, reads the sensed capacitance values at sensed points intersected by the driven first traces Y₁˜Yₙ and all the second traces X₁˜Xₘ with a fixed frequency or preset different frequencies, and acquires capacitance offsets corresponding to the sensed points. After all the first traces Y₁˜Yₙ are driven, the capacitance offsets of all the sensed points are acquired.

Step S21: The control unit 23 calculates the capacitance offset of each first trace Y₁˜Yₙ with the capacitance offsets of the sensed points on the first trace Y₁˜Yₙ. For example, the capacitance offset of any sensed point on each first trace Y₁˜Yₙ or an average value of the capacitance offsets of all the sensed points on the first trace Y₁˜Yₙ is taken as the capacitance offset of the first trace Y₁˜Yₙ.

Step S22: The mutual-capacitance scan circuit performs an analog-to-digital conversion (ADC) calibration procedure with respect to the sensing unit 10 under the mutual-capacitance scan mode, and sequentially outputs the driving signal to the first traces Y₁˜Yₙ.

Step S23: The receiving unit 22 determines a sampling frequency of each first trace according to the capacitance offset of the first traces when the driving unit 21 is controlled to output the driving signal, and stores the sampling frequency in the receiving unit 22.

Step S24: The receiving unit 22 senses capacitive signals at the sensed points intersected by the second traces X₁˜Xₘ and the driven first traces Y₁˜Yₙ with the corresponding sampling frequencies, respectively converts the sensed capacitive signals into sensed capacitance values, and outputs the sensed capacitance values to the control unit 23.

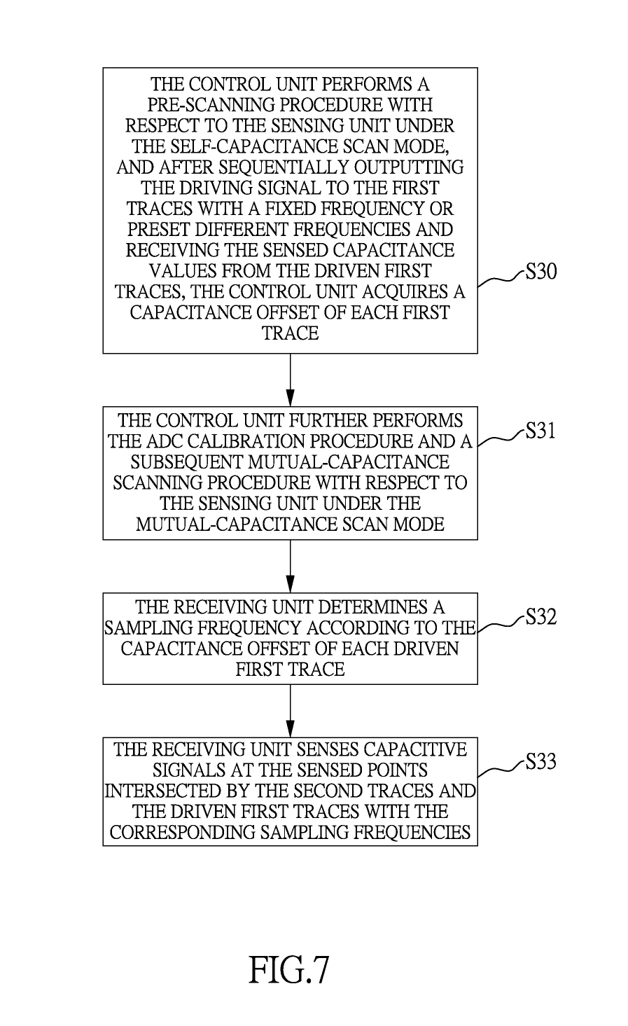

With reference to FIGS. 1 and 7, a second embodiment of the scanning method in accordance with the present invention is applied to a self-capacitance and mutual-capacitance scan circuit. Although a driving signal is outputted to a sensor trace and a sensed capacitance signal is received from the same sensor trace under a self-capacitance scan mode, the issue of different RC loads does not seemingly exist. However, each connection wire L between the driving unit 21 and a corresponding sensor trace varies with a mounting location of the driving unit 21. Hence, different RC loads still arise from the connection wires with different lengths, and the capacitance offset of each sensor trace can still be acquired by scanning the sensor trace under the self-capacitance scan mode. The second embodiment of the scanning method is performed by the touch device and has the following steps.

Step S30: The control unit 23 performs a pre-scanning procedure with respect to the sensing unit 10 under the self-capacitance scan mode. In the pre-scanning procedure, the control unit 23 sequentially outputs the driving signal to the first traces Y₁˜Yₙ with a fixed frequency or preset different frequencies and receives the sensed capacitance values from the driven first traces Y₁˜Yₙ, and then acquires a capacitance offset of each first trace Y₁˜Yₙ.

Step S31: The control unit 23 further performs the ADC calibration procedure and a subsequent mutual-capacitance scanning procedure with respect to the sensing unit 10 under the mutual-capacitance scan mode, and sequentially outputs the driving signal to the first traces Y₁˜Yₙ.

Step S32: The receiving unit 22 determines a sampling frequency according to the capacitance offset of each driven first trace when the driving unit 21 is controlled to output the driving signal, and stores the sampling frequencies in the receiving unit 22.

Step S33: The receiving unit 22 senses capacitive signals at the sensed points intersected by the second traces X₁˜Xₘ and the driven first traces Y₁˜Yₙ with the corresponding sampling frequencies, converts the sensed capacitive signals into sensed capacitance values, and outputs the sensed capacitance values to the control unit 23.

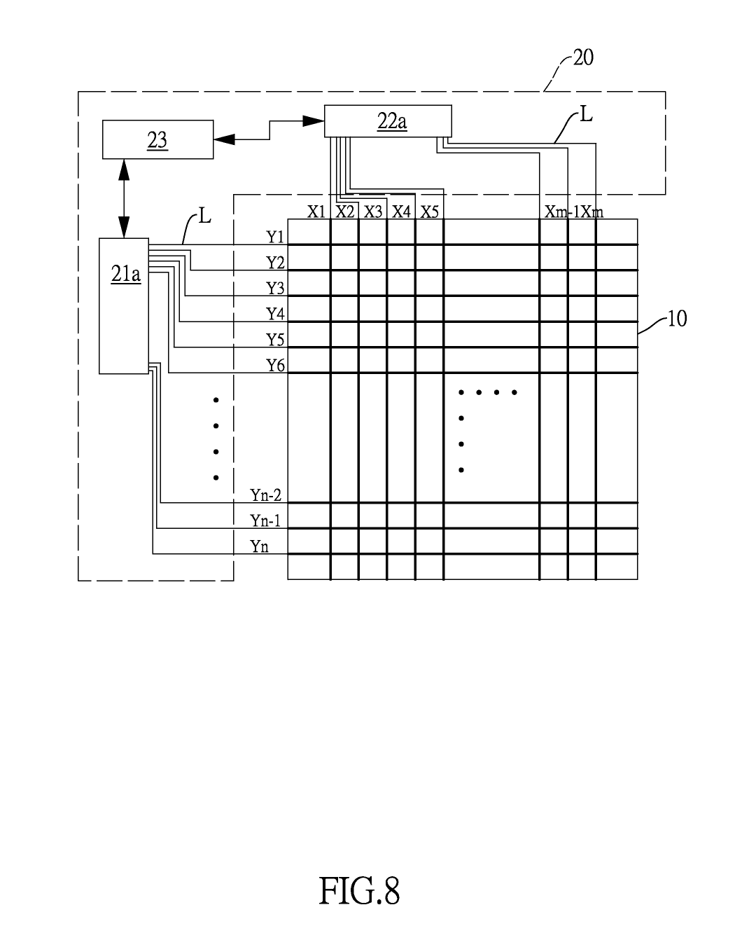

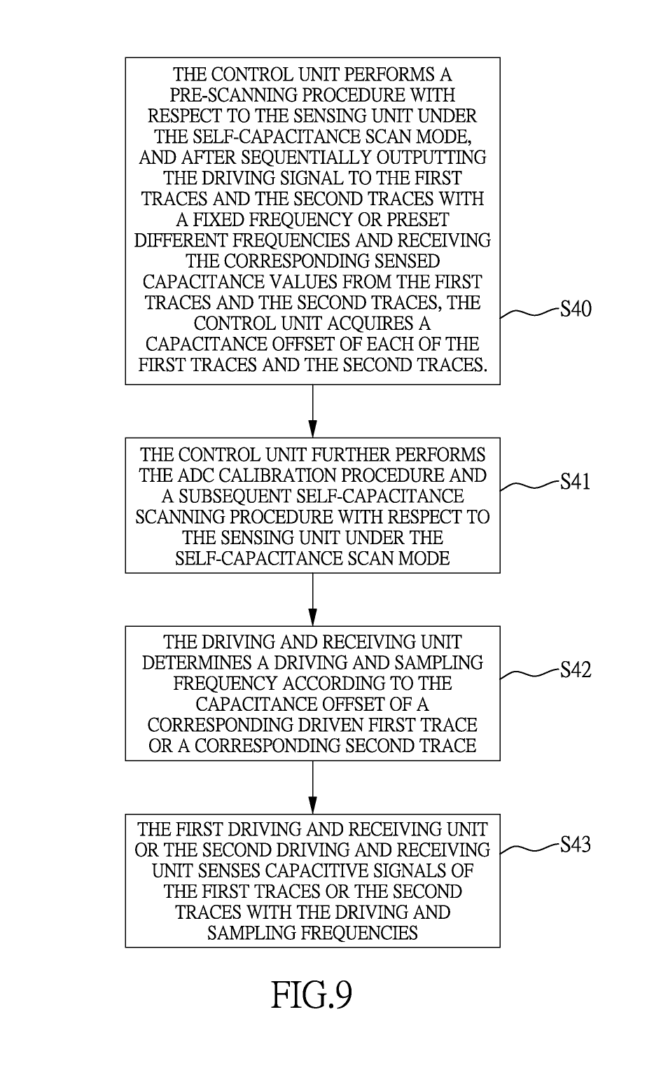

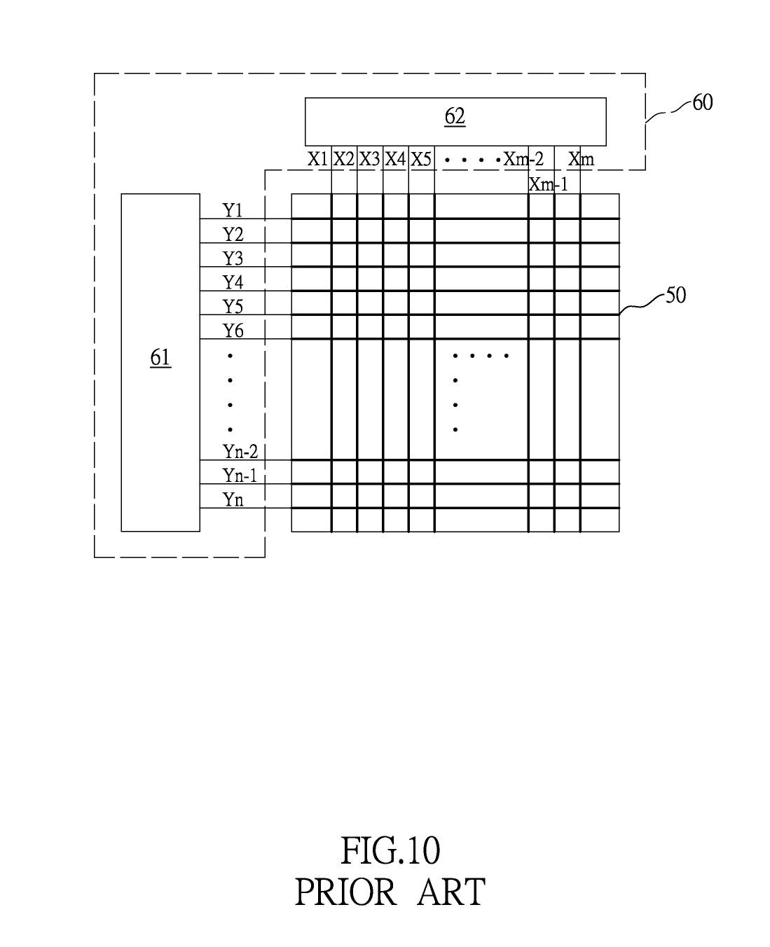

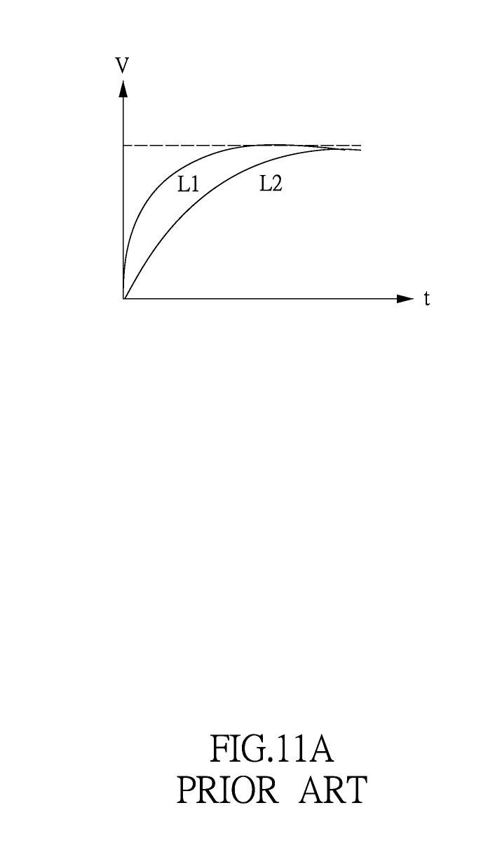

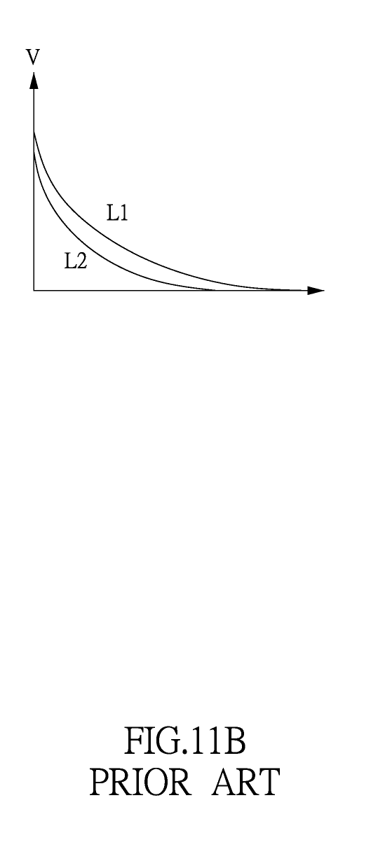

With reference to FIGS. 1, 8 and 9, a third embodiment of the scanning method in accordance with the present invention is applied to a self-capacitance scan circuit. The self-capacitance scan circuit has a first driving and receiving unit 21a, a second driving and receiving unit 22a, and a control unit 23. The third embodiment of the scanning method has the following steps.

Step S40: The control unit 23 performs a pre-scanning procedure with respect to the sensing unit 10 under the self-capacitance scan mode. In the pre-scanning procedure, the control unit 23 sequentially outputs the driving signal to the first traces Y₁˜Yₙ and the second traces X₁˜Xₘ with a fixed frequency or preset different frequencies and receives the corresponding sensed capacitance values from the first traces Y₁˜Yₙ and the second traces X₁˜Xₘ, and then acquires a capacitance offset of each of the first traces Y₁˜Yₙ and the second traces X₁˜Xₘ.

Step S41: The control unit 23 further performs the ADC calibration procedure and a subsequent self-capacitance scanning procedure with respect to the sensing unit 10 under the self-capacitance scan mode, and sequentially outputs the driving signal to the first traces Y₁˜Yₙ and the second traces X₁˜Xₘ.

Step S42: The driving and receiving unit 21a, 22a determines a driving and sampling frequency according to the capacitance offset of a corresponding driven first trace Y₁˜Yₙ or a corresponding second trace X₁˜Xₘ when the driving unit 21 is controlled to output the driving signal, and stores the driving and sampling frequency in the first driving and receiving unit 21a or the second driving and receiving unit 22a.

Step S43: The first driving and receiving unit 21a or the second driving and receiving unit 22a senses capacitive signals of the first traces Y₁˜Yₙ or the second traces X₁˜Xₘ with the driving and sampling frequencies, converts the sensed capacitive signals into sensed capacitance values, and outputs the sensed capacitance values to the control unit 23.

As regular touch devices are rectangular in shape, the first traces Y₁˜Yₙ aligned along the first-axis direction (longitudinal side) are more prone to the issue of different RC loads arising from the lengths of the connection wires L than the second traces X₁˜Xₘ aligned along the second-axis direction (lateral side), only the first traces Y₁˜Yₙ may be scanned during the foregoing pre-scanning procedure to acquire the capacitance offsets of the first traces Y₁˜Yₙ. Thus, in the following self-capacitance scanning procedure, the first driving and receiving unit 21a performs the self-capacitance scanning procedure with respect to the first traces Y₁˜Yₙ with the driving and sampling frequencies determined according to the corresponding driving and sampling frequencies of the first traces Y₁˜Yₙ, and the second driving and receiving unit 22a performs the self-capacitance scanning procedure with respect to the second traces X₁˜Xₘ with the preset fixed frequency or the preset different frequencies.

There are several approaches for the control unit 23 to determine current sampling frequencies for the receiving unit 22 according to the corresponding capacitance offsets of the first traces.

Approach I: The control unit 23 first configures a lowest first sampling frequency reference value corresponding to a highest capacitance offset so that the capacitance offsets of the first traces progressively decreasing in magnitude correspond to the respective sampling frequencies progressively increasing from the lowest first sampling frequency reference value. Alternatively, the control unit 23 first configures a highest second sampling frequency reference value corresponding to a lowest capacitance offset so that the capacitance offsets of the first traces progressively increasing in magnitude correspond to the respective sampling frequencies progressively decreasing from the highest first sampling frequency reference value. Thus, a range of the sampling frequencies can be determined according to the corresponding capacitance offsets of the driven first traces.

Approach II: The control unit can set up a lookup table. The lookup table contains various capacitance offsets and corresponding sampling frequencies. A sampling frequency can be mapped in the lookup table by referring to the capacitance offset of a corresponding driven first trace in the lookup table.

From the foregoing first to third embodiments, irrespective of the applications of the mutual-capacitance scan circuit, the self-capacitance and mutual-capacitance scan circuit and the self-capacitance circuit, the present invention always performs a pre-scanning procedure with respect to the sensing unit 10 to acquire the capacitance offsets of the first traces and the second traces or either one of the first traces and the second traces, configures a sampling frequency according to a corresponding capacitance offset upon subsequent scanning, and scans the sensing unit 10 with the sampling frequencies. Hence, a higher sampling frequency is configured to correspond to a lower RC load of a sensor trace in the subsequent scanning, and a lower sampling frequency is configured to a higher RC load of a sensor trace. The present invention can not only acquire the sensed capacitance values more accurate than those acquired by using a fixed sampling frequency, but also can automatically adjust the sampling frequencies. In comparison with manual measurements for RC loads of sensor traces and suitable sampling frequencies, the present invention is simpler and more time-saving and provides a higher coordinate report rate of a touch object.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

1. A scanning method with adjustable sampling frequency for a sensing unit having multiple sensor traces aligned in a first-axis direction and in a second-axis direction, the scanning method comprising steps of:
scanning the sensing unit to acquire capacitance offsets of the sensor traces respectively in the first-axis direction;
driving each sensor trace in the first-axis direction;
determining sampling frequencies according to the capacitance offsets of the respective driven sensor traces in the first-axis direction; and
reading sensed capacitance values at locations intersected by the sensor traces in the second-axis direction and the driven sensor traces in the first-axis direction with the corresponding sampling frequencies.

2. The scanning method as claimed in claim 1, wherein in the step of scanning the sensing unit to acquire the capacitance offsets of the sensor traces in the first-axis direction, each sensor trace in the first-axis direction of the sensing unit is driven and read with a fixed frequency to acquire the capacitance offsets corresponding to the sensor traces in the first-axis direction under a self-capacitance scanning procedure.

3. The scanning method as claimed in claim 1, wherein in the step of scanning the sensing unit, the sensor traces in the first-axis direction are driven and the sensor traces in the second-axis direction are read with a fixed frequency to acquire the capacitance offsets at sensed points intersected by the sensor traces in the first-axis direction and in the second-axis direction under a mutual-capacitance scanning procedure, and calculate the capacitance offsets of all the sensed points on each sensor trace in the first-axis direction to generate the capacitance offset corresponding to the sensor trace in the first-axis direction.

4. The scanning method as claimed in claim 3, wherein the capacitance offset of each sensor trace in the first-axis direction is generated by taking an average of the capacitance offsets of all the sensed points on the sensor trace in the first-axis direction.

5. The scanning method as claimed in claim 3, wherein the capacitance offset of each sensor trace in the first-axis direction is generated by selecting the capacitance offset of any one of the sensed points on the sensor trace in the first-axis direction.

6. The scanning method as claimed in claim 1, wherein the step of determining sampling frequencies includes steps of:
configuring a first sampling frequency reference value corresponding to a highest one of the capacitance offsets of the sensor traces in the first-axis direction; and
configuring the sampling frequencies according to the corresponding capacitance offsets of the sensor traces in the first-axis direction, wherein the capacitance offsets of the sensor traces in the first-axis direction progressively decreasing in magnitude correspond to the respective sampling frequencies progressively increasing from the first sampling frequency reference value.

7. The scanning method as claimed in claim 1, wherein the step of determining sampling frequencies further includes steps of:
configuring a second sampling frequency reference value corresponding to a lowest one of the capacitance offsets of the sensor traces in the first-axis direction; and
configuring the sampling frequencies according to the corresponding capacitance offsets of the sensor traces in the first-axis direction, wherein the capacitance offsets of the sensor traces in the first-axis direction progressively increasing in magnitude correspond to the respective sampling frequencies progressively decreasing from the second sampling frequency reference value.

8. The scanning method as claimed in claim 1, wherein the step of determining sampling frequencies includes steps of:
configuring a lookup table, wherein the lookup table has multiple capacitance offsets and multiple sampling frequencies corresponding to the capacitance offsets; and
mapping the capacitance offset of each driven sensor trace in the first-axis direction onto a corresponding sampling frequency in the lookup table.

9. A scanning method with adjustable sampling frequency of a sensing unit having multiple sensor traces aligned in a first-axis direction and in a second-axis direction, the scanning method comprising steps of:
a pre-scanning procedure having a step of acquiring capacitance offsets corresponding to at least the sensor traces in the first direction; and
a subsequent scanning procedure having steps of:
determining a driving and sampling frequency of each sensor trace in the first-axis direction according to the capacitance offset of the sensor trace in the first-axis direction; and
driving the sensor trace in the first-axis direction and reading sensed capacitance value of the sensor trace in the first-axis direction with the driving and sampling frequency of the sensor trace in the first-axis direction.

10. The scanning method as claimed in claim 9, wherein
the pre-scanning procedure further includes a step of acquiring capacitance offsets corresponding to the sensor traces in the second-axis direction;
the subsequent scanning procedure includes steps of:
determining a driving and sampling frequency of each sensor trace in the second-axis direction according to the capacitance offset of the sensor trace in the second-axis direction; and
driving the sensor trace in the first-axis direction and reading sensed capacitance value of the sensor trace in the second-axis direction with the driving and sampling frequency of the sensor trace in the second-axis direction.

11. The scanning method as claimed in claim 9, wherein the subsequent scanning procedure further includes a step of driving the sensor traces in the second-axis direction and reading sensed capacitance values of the sensor traces in the second-axis direction with a fixed frequency.

12. The scanning method as claimed in claim 9, wherein the subsequent scanning procedure further has a step of driving and reading the sensor traces in the first-axis direction with a fixed frequency under a self-capacitance scan mode to acquire the capacitance offset of each sensor trace in the first-axis direction.

13. The scanning method as claimed in claim 12, wherein the step of determining a driving and sampling frequency of each sensor trace in the first-axis direction includes steps of:
configuring a first sampling frequency reference value corresponding to a highest one of the capacitance offsets of the sensor traces in the first-axis direction; and
configuring the sampling frequencies according to the corresponding capacitance offsets of the sensor traces in the first-axis direction, wherein the capacitance offsets of the sensor traces in the first-axis direction progressively decreasing in magnitude correspond to the respective sampling frequencies progressively increasing from the first sampling frequency reference value.

14. The scanning method as claimed in claim 12, wherein the step of determining a driving and sampling frequency of each sensor trace in the first-axis direction includes steps of:
configuring a second sampling frequency reference value corresponding to a lowest one of the capacitance offsets; and
configuring the sampling frequencies according to the corresponding capacitance offsets of the sensor traces in the first-axis direction, wherein the capacitance offsets of the sensor traces in the first-axis direction progressively increasing in magnitude correspond to the respective sampling frequencies progressively decreasing from the second sampling frequency reference value.

15. The scanning method as claimed in claim 12, wherein the step of determining a driving and sampling frequency of each sensor trace in the first-axis direction includes steps of:
configuring a lookup table, wherein the lookup table has multiple capacitance offsets and multiple sampling frequencies corresponding to the capacitance offsets; and
mapping the capacitance offset of each driven sensor trace in the first-axis direction onto a corresponding sampling frequency in the lookup table.

16. A touch device with adjustable sampling frequency, comprising:
a sensing unit having multiple sensor traces aligned in a first-axis direction and in a second-axis direction;
a driving unit connected to the sensor traces in the first-axis direction of the sensing unit;
a receiving unit connected to the sensor traces in the second-axis direction of the sensing unit; and
a control unit connected to the driving unit and the receiving unit, controlling the driving unit and the receiving unit to scan the sensing unit so as to acquire capacitance offsets of the sensor traces in at least the first-axis direction, and determining sampling frequencies according to the capacitance offsets of the respective driven sensor traces in the first-axis direction;
wherein the receiving unit reads sensed capacitance values at locations intersected by the sensor traces in the second-axis direction and the driven sensor traces in the first-axis direction with the corresponding sampling frequencies.

17. The touch device as claimed in claim 16, wherein the control unit is built in with a self-capacitance scanning procedure, performs the self-capacitance scanning procedure to control the driving unit and the receiving unit to drive and read the sensor traces in the first-axis direction of the sensing unit with a fixed frequency and to acquire the capacitance offset of each sensor trace in the first-axis direction.

18. The touch device as claimed in claim 16, wherein the control unit is built in with a mutual-capacitance scanning procedure, performs the mutual-capacitance scanning procedure to control the driving unit to drive the sensor traces in the first-axis direction and read the sensor traces in the second-axis direction with a fixed frequency and to acquire the capacitance offsets of multiple sensed points intersected by the sensor traces in the first-axis direction and in the second-axis direction, wherein the capacitance offsets of all the sensed points on each sensor trace in the first-axis direction are calculated to generate the capacitance offset of the sensor trace in the first-axis direction.

19. The touch device as claimed in claim 18, wherein the capacitance offset of each sensor trace in the first-axis direction generated by the control unit is an average value of the capacitance offsets of all the sensed points on the sensor trace in the first-axis direction.

20. The touch device as claimed in claim 18, wherein the capacitance offset of each sensor trace in the first-axis direction generated by the control unit is the capacitance offset of any selected sensed point on the sensor trace in the first-axis direction.

21. The touch device as claimed in claim 16, wherein the control unit configures a first sampling frequency reference value corresponding to a highest one of the capacitance offsets of the sensor traces in the first-axis direction, and configures the sampling frequencies according to the corresponding capacitance offsets of the sensor traces in the first-axis direction, wherein the capacitance offsets of the sensor traces in the first-axis direction progressively decreasing in magnitude correspond to the respective sampling frequencies progressively increasing from the first sampling frequency reference value.

22. The touch device as claimed in claim 16, wherein the control unit configures a second sampling frequency reference value corresponding to a lowest one of the capacitance offsets of the sensor traces in the first-axis direction, and configures the sampling frequencies according to the corresponding capacitance offsets of the sensor traces in the first-axis direction, wherein the capacitance offsets of the sensor traces in the first-axis direction progressively increasing in magnitude correspond to the respective sampling frequencies progressively decreasing from the second sampling frequency reference value.

23. The touch device as claimed in claim 16, wherein the control unit stores a lookup table having multiple capacitance offsets and multiple sampling frequencies corresponding to the capacitance offsets, maps the capacitance offset of each sensor trace in the first-axis direction driven upon subsequently performing the mutual-capacitance scanning procedure onto a corresponding sampling frequency in the lookup table for the receiving unit to receive the sensed capacitance values on a corresponding sensor trace in the second-axis direction with the mapped sampling frequency.

24. The touch device as claimed in claim 16, wherein the receiving unit has:
a multiplexer having:
multiple select terminals respectively connected to the sensor traces in the first-axis direction;
a control terminal connected to the control unit; and
a common terminal;
a variable capacitance compensation circuit connected to the control unit;
a comparator having an input terminal connected to the common terminal of the multiplexer and the variable capacitance compensation circuit; and
an analog-to-digital conversion (ADC) circuit having:
an analog input terminal connected to an output terminal of the comparator; and
a digital output terminal connected to the control unit.

25. The touch device as claimed in claim 16, wherein the receiving unit has multiple receivers, and each receiver has:
a variable capacitance compensation circuit connected to the control unit;
a comparator having an input terminal connected to a corresponding sensor trace in the first-axis direction and the variable capacitance compensation circuit; and
an analog-to-digital conversion (ADC) circuit having:
an analog input terminal connected to an output terminal of the comparator; and
a digital output terminal connected to the control unit.

26. The touch device as claimed in claim 24, wherein the variable capacitance compensation circuit has:
multiple capacitors, wherein one end of each capacitor is connected to the input terminal of the comparator; and
multiple electronic switches, each electronic switch connected between the other end of a corresponding capacitor and a ground terminal with a control terminal of the electronic switch connected to the control unit.

27. The touch device as claimed in claim 25, wherein the variable capacitance compensation circuit has:
multiple capacitors, wherein one end of each capacitor is connected to the input terminal of the comparator; and
multiple electronic switches, each electronic switch connected between the other end of a corresponding capacitor and a ground terminal with a control terminal of the electronic switch connected to the control unit.

28. A touch device with adjustable sampling frequency, comprising:
a sensing unit having multiple sensor traces aligned in a first-axis direction and in a second-axis direction;
a first driving and receiving unit connected to the sensor traces in the first-axis direction;
a second driving and receiving unit connected to the sensor traces in the second-axis direction; and
a control unit connected to the first driving and receiving unit and the second driving and receiving unit, controlling the first driving and receiving unit and the second driving and receiving unit to pre-scan the sensing unit and at least acquire a capacitance offset of each sensor trace in the first-axis direction, determining a first driving and sampling frequency of each sensor trace in the first-axis direction according to the capacitance offset of the sensor trace in the first-axis direction, and driving the sensor trace in the first-axis direction and reading sensed capacitance value of the sensor trace in the first-axis direction with the first driving and sampling frequency when scanning the sensor traces subsequently.

29. The touch device with adjustable sampling frequency as claimed in claim 28, wherein the control unit pre-scans the sensing unit and further acquires a capacitance offset of each sensor trace in the second-axis direction, determines a second driving and sampling frequency of each sensor trace in the second-axis direction according to the capacitance offset of the sensor trace in the second-axis direction when subsequently scanning the sensor traces in the second-axis direction, and controls the second driving and receiving unit to drive each sensor trace in the second-axis direction and read sensed capacitance value of each sensor trace in the second-axis direction with the second driving and sampling frequency.

30. The touch device with adjustable sampling frequency as claimed in claim 28, wherein the control unit controls the second driving and receiving unit to drive each sensor trace in the second-axis direction and read the sensed capacitance value of the sensor trace in the second-axis direction with a fixed frequency when scanning the sensors traces subsequently.

31. The touch device with adjustable sampling frequency as claimed in claim 28, wherein the control unit is built in with a self-capacitance scanning procedure, performs the self-capacitance scanning procedure to control the first driving and receiving unit to drive and read the sensor traces in the first-axis direction of the sensing unit with a fixed frequency, and to acquire the capacitance offset of each sensor trace in the first-axis direction.

32. The touch device with adjustable sampling frequency as claimed in claim 31, wherein the control unit configures a first sampling frequency reference value corresponding to a highest one of the capacitance offsets of the sensor traces in the first-axis direction, and configures the sampling frequencies according to the corresponding capacitance offsets of the sensor traces in the first-axis direction, wherein the capacitance offsets of the sensor traces in the first-axis direction progressively decreasing in magnitude correspond to the respective sampling frequencies progressively increasing from the first sampling frequency reference value.

33. The touch device with adjustable sampling frequency as claimed in claim 31, wherein the control unit configures a second sampling frequency reference value corresponding to a lowest one of the capacitance offsets of the sensor traces in the first-axis direction, and configures the sampling frequencies according to the corresponding capacitance offsets of the sensor traces in the first-axis direction, wherein the capacitance offsets of the sensor traces in the first-axis direction progressively increasing in magnitude correspond to the respective sampling frequencies progressively decreasing from the second sampling frequency reference value.

34. The touch device with adjustable sampling frequency as claimed in claim 31, wherein the control unit stores a lookup table having multiple capacitance offsets and multiple sampling frequencies corresponding to the capacitance offsets, maps the capacitance offset of each sensor trace in the first-axis direction driven upon subsequently performing the mutual-capacitance scanning procedure onto a corresponding sampling frequency in the lookup table for the receiving unit to receive the sensed capacitance values on a corresponding sensor trace in the second-axis direction with the mapped sampling frequency.

35. A scanning method with adjustable sampling frequency for a sensing unit having multiple sensor traces aligned in a first-axis direction and in a second-axis direction, the scanning method comprising steps of:
pre-scanning the sensing unit to acquire a capacitance offset corresponding to each sensor trace in at least one of the first-axis direction and the second-axis direction;
determining a sampling frequency according to the capacitance offset of the sensor trace; and
sampling the sensor unit with the determined sampling frequencies.

36. The scanning method as claimed in claim 35, wherein the step of pre-scanning the sensing unit includes a step of driving and reading each sensor trace in the first-axis direction with a fixed frequency under a self-capacitance scan mode to acquire the capacitance offset of the sensor trace in the first-axis direction.

37. The scanning method as claimed in claim 35, wherein the step of pre-scanning the sensing unit further includes steps of:
driving the sensor traces in the first-axis direction and reading the sensor traces in the second-axis direction with a fixed frequency to acquire the capacitance offsets at sensed points intersected by the sensor traces in the first-axis direction and the second-axis direction; and
calculating the capacitance offsets of all the sensed points on each sensor trace in the first-axis direction to generate the capacitance offset corresponding to the sensor trace in the first-axis direction.
